(19) United States
(12) Patent Application Publication
(10) Pub. No.: US 2018/0184101 A1
(43) Pub. Date: Jun. 28, 2018

(54) Coding Mode Selection For Predictive Video Coder/Decoder Systems In Low-Latency Communication Environments

(71) Applicant: Apple Inc., Cupertino, CA (US)

(72) Inventor: Keangpo Ricky Ho, San Jose, CA (US)

(21) Appl. No.: 15/390,130

(22) Filed: Dec. 23, 2016

(51) Int. Cl. H04N 19/50; H04N 19/159; H04N 19/182

(52) U.S. Cl. CPC H04N 19/50; H04N 19/182; H04N 19/159

(57) ABSTRACT

Techniques are disclosed for coding video in the present of transmission errors experience in a network. When a new coding unit is presented for coding, a transmission state of a co-located coding unit from a preceding frame may be determined. If the transmission state of the co-located coding unit from the preceding frame indicates an error, an intra-coding mode may be selected for the new coding unit. If the transmission state of the co-located coding unit from the preceding frame does not indicate an error, a coding mode may be selected for the new coding unit according to a default process. The new coding unit may be coded according to the selected coding mode, and transmitting across a network. These techniques find ready application in network environments that provide low latency acknowledgments of transmitted data.

### BACKGROUND

The present disclosure applied to video coding systems and, in particular, to such system that operate in communication environments where transmission errors are likely and the video systems require low latency.

Modern video coding systems exploit temporal redundancy in video data to achieve bit rate compression. When temporal redundancies are detected across frames, a new frame may be coded differentially with regard to “prediction references,” elements of previously-coded data that are known both to an encoder and a decoder. A prediction chain is developed between the new frame and the reference frame because, once coded, the new frame cannot be decoded without error unless the decoder has access both to decoded data of the reference frame and coded residual data of the new frame. And, when prediction chains are developed that link several frames to a common reference frame, a loss of the reference frame can induce a loss of data for all frames that are linked to it by the prediction chains.

Because loss of reference picture data can cause loss of data, not only to the reference picture itself, but also to in other coded frames, system designers have employed various protocols that cause encoders and decoders to confirm successful receipt of coded video data. One such technique involves use of Instantaneous Decoder Refresh (IDR) frames. IDR frames are coded frames that are designated as such by an encoder and transmitted to a decoder. Ideally, an encoder does not use the IDR frame as a reference frame until it has been decoded successfully by a decoder, and an acknowledgment message of such decoding is received by an encoder. Such techniques, however, involve long latency times between the time a frame is coded as an acknowledged IDR frame and the time that the acknowledged IDR frame can be used for prediction.

The inventor perceives a need in the art for establishing reliable communication between an encoder and a decoder for coded video data, for identifying transmission errors between the encoder and decoder quickly, and for responding to such transmission errors to minimize data loss between them.

### BRIEF DESCRIPTION OF THE DRAWINGS

FIG. 1 illustrates a video coding/decoding system according to an embodiment of the present disclosure.

FIG. 2 illustrates a method according to an embodiment of the present disclosure.

FIGS. 3(a)-(c) illustrate exemplary frames to be processed according to various embodiments of the present disclosure.

FIG. 4 illustrates exemplary coding of source video in the presence of transmission errors within a network according to an embodiment of the present disclosure.

FIG. 5 is a flow diagram of a method according to another embodiment of the present invention.

FIG. 6 is a functional block diagram of a coding system according to an embodiment of the present disclosure.

FIG. 7 is a functional block diagram of a decoding system according to an embodiment of the present disclosure.

FIG. 8 illustrates exemplary coding of source video in the presence of transmission errors within a network according to another embodiment of the present disclosure.

FIG. 9 illustrates an exemplary computer system suitable for use with embodiments of the present disclosure.

### DETAILED DESCRIPTION

Embodiments of the present disclosure provide techniques for coding video in the presence of transmission errors experience in a network, especially a wireless network with low latency. When a new coding unit is presented for coding, a transmission state of a co-located coding unit from a preceding frame may be determined. If the transmission state of the co-located coding unit from the preceding frame indicates an error, an intra-coding mode may be selected for the new coding unit. If the transmission state of the co-located coding unit from the preceding frame does not indicate an error, a coding mode may be selected for the new coding unit according to a default process depending on the video itself. The new coding unit may be coded according to the selected coding mode, and transmitting across a network. The foregoing techniques find ready application in network environments that provide low latency acknowledgments of transmitted data.

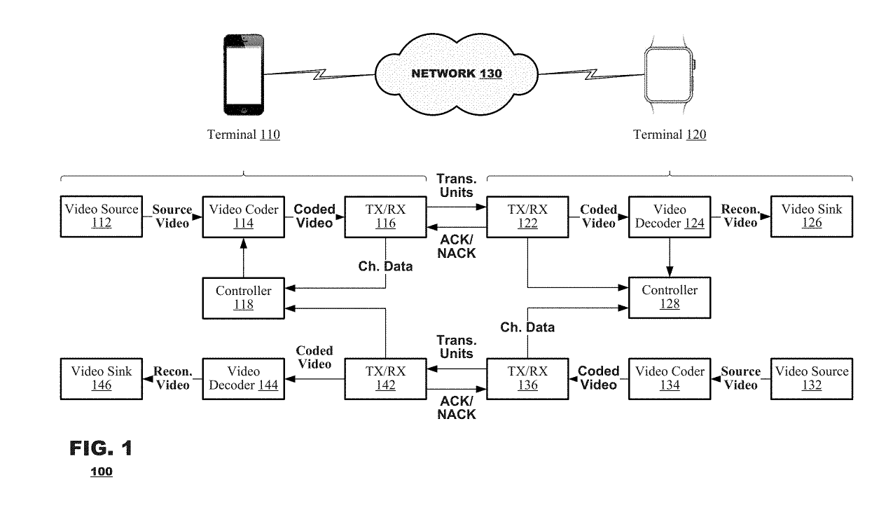

FIG. 1 illustrates a video coding/decoding system 100 according to an embodiment of the present disclosure. The system 100 may include a pair of terminals 110, 120 provided in mutual communication by a communication network 130. The terminals 110, 120 may exchange coded video data with each other via the network 130, either in a unidirectional or bidirectional exchange. For unidirectional exchange, a first terminal 110 may code local video content and transmit the coded video data to a second terminal 120. The second terminal 120 may decode the coded video data that it receives from the first terminal 110. For bidirectional exchange, each terminal 110, 120 may code video data locally and transmit its coded video data to the other terminal. Each terminal 110, 120 also may decode the coded video data that it receives from the other terminal for local processing.

Communication losses may arise between transmission of coded video by the first terminal 110 and reception of coded video data by the second terminal 120. Communication losses may be more serious in wireless communication networks with time varying media, interference, and other channel impairments. The second terminal 120 may generate data indicating which portions of coded video data were successfully received and which were not; the second terminal's acknowledgment data may be transmitted from the second terminal 120 to the first terminal 110. In an embodiment, the first terminal 110 may use the acknowledgment data to manage coding operations for newly received video data.

FIG. 1 illustrates major operational units of the first and second terminals 110, 120 in block diagram form, for a bidirectional system as an example. The first terminal 110 may include a video source 112, a video coder 114, a transceiver 116 (shown as “TX/RX”), and a controller 118. The video source 112 may provide source video data to the video coder 114 for coding. Exemplary video sources include camera systems for capturing video data of a local environment in which the first terminal 110 operates, video data generated by applications (not shown) executing on the first terminal 110 and/or video data received by the first terminal 110 from some other source, such as a computer server (also not shown). Differences among the different types of video sources 112 are immaterial to the present disclosure unless described hereinbelow.

The video coder 114 may code input video data according to a predetermined process to achieve bandwidth compression. The video coder exploits spatial and/or temporal redundancy in input video data by coding new video data differentially with reference to previously-coded video data. The video coder 114 may operate according to a predetermined coding processes, as conforming to H.265 (HEVC), H.264, H.261 and/or one of the MPEG coding standards (e.g., MPEG-4 or MPEG-2). The video coder 114 may output video data to the transceiver 116.

The video coder 114 may partition an input frame into a plurality of “pixel blocks,” spatial areas of the frame, which may be processed in sequence. The pixel blocks may be coded differentially with reference to previously coded data either from another area in the same frame (intra-prediction), or from an area in other frames (inter-prediction). Intra-prediction coding becomes efficient when there is a high level of redundancy spatially within a frame being coded. Inter-prediction coding becomes efficient when there is a high level of redundancy temporally among a sequence of frames being coded. For a new pixel block to be coded, the video coder 114 typically tests each of the candidate coding modes available to it to determine which coding mode, intra-prediction or inter-prediction, will achieve the highest compression efficiency. Typically, there are several variants available to the video coder 114 both under intra-prediction and inter-prediction and, depending on implementation, the video coder 114 may test them all. When a prediction mode is selected and a prediction reference is identified, the video coder 114 may perform additional processing of pixel residuals, the pixel-wise differences between the input pixel block and the prediction pixel block identified from the mode selection processing, to improve quality of recovered images data that would be obtained by prediction alone. The video coder 114 may generate data representing the coded pixel block, which may include a prediction mode selection, an identifier of a reference pixel block used in prediction and processed residual data. Different coding modes may generate different types of coded pixel block data.

The transceiver 116 may transmit coded video data to the second terminal 120. The transceiver 116 may organize coded video data, perhaps along with data from other sources within the first terminal (say, audio data and/or other informational content) into transmission units for transmission via the network 130. The transmission units may be formatted according to transmission requirements of the network 130. Thus, the transceiver 116, together with its counterpart transceiver 122 in the second terminal 120, may handle processes associated with physical layer, data link layer, networking layer, and transport layer management in communication between the first and second terminals 110, 120. In an embodiment, some of the layers may be by-passed by the video data to improve the system latency.

The transceiver 116 also may receive acknowledgement messages (shown as ACK for positive acknowledge or NACK messages for the equivalent of negative/no acknowledgement) that are transmitted by the second terminal 120 to the first terminal 110 via the network 130. The acknowledgment messages may identify transmission units that were transmitted from the first terminal 110 to the second terminal 120 that either were or were not received properly by the second terminal 120. The transceiver 116 may identify to the controller 118 transmission units that either were or were not received properly by the second terminal 120.

Optionally, the transceiver 116 also may perform its own estimation processes to estimate quality of a communication connection within the network 130 between the first and second terminals 110, 120. For example, the transceiver 116 may estimate signal strength or the variations of signal strength of communication signals that the transceiver 116 receives from the network 130. The transceiver 116 alternatively may estimate bit error rates or packet error rates of transmissions it receives from the network 130. The transceiver 116 may estimate an overall quality level of communication between the first and second terminals 110, 120 based on such estimations and it may identify the estimated quality level to the controller 118. In some networks, the channel estimation may be based on the principle of reciprocity that the channels from 122 to 116 and 116 to 122 have certain shared properties. In some networks, the channel condition may be estimated in the receiver of transceiver 122 and feedback to the transceiver 116.

The controller 118 may manage operation of the video source 112, the video coder 114 and the transceiver 116 of the first terminal 100. It may store data that correlates coding units that are processed by the video coder 114 and the transmission units to which the transceiver 116 assigned them. Thus, when acknowledgment and/or error messages are received by the transceiver 116, the controller 118 may identify the coding units that may have been lost when transmission errors caused loss of transmission units. The controller 118 may manage coding operations of the first terminal 100 as described herein and, in particular, may engage error recovery processes in response to identification of transmission errors between the first and second terminals 110, 120.

The second terminal 120 may include a transceiver 122, a video decoder 124, a video sink 126 and a controller 128. The transceiver 122, along with the transceiver 116 in the first terminal 110, may handle processes associated with physical layer, data link layer, networking layer, and transport layer management in communication between the first and second terminals 110, 120. The transceiver 122 may receive transmission units from the network 130 and parse the transmission units into their constituent data types, for example, distinguishing coded video data from audio data and any other information or control content transmitted by the first terminal 110. The transceiver 122 may forward the coded video data retrieved from the transmission units to the video decoder 124.

The video decoder 124 may decode coded video data from the transceiver according to the protocol applied by the video encoder 114. The video decoder 124 may invert coding processes applied by the video encoder 114. Thus, for each pixel block, the video decoder 124 may identify a prediction mode that was used to code the pixel block and a reference pixel block. The video decoder 124 may invert the processing of any pixel residuals and add pixel data obtained therefrom the pixel data of the reference pixel block(s) used for prediction. The video decoder 124 may assemble reconstructed frames from decoded pixel block(s), which may be output from the decoder 124 to the video sink 126. Typically, processes of the video coder 114 and the video decoder 124 are lossy processes and, therefore, the reconstructed frames may possess some amount of video distortion as compared to the source frames from which they were derived.

The video sink 126 may consume the reconstructed frames. Exemplary video sink devices include display devices, storage devices and application programs. For example, reconstructed frames may be displayed immediately on decode by a display device, typically an LCD- or LED-based display device. Alternatively, reconstructed frames may be stored by the second terminal 120 for later use and/or review. In a further embodiment, the reconstructed frames may be consumed by an application program that executes on the second terminal 120, for example, a video editor, a gaming application, a machine learning application or the like. Differences among the different types of video sinks 126 are immaterial to the present disclosure unless described hereinbelow.

The components of the first and second terminals 110, 120 discussed thus far support exchange of coded video data in one direction only, from the first terminal 110 to the second terminal 120. To support bidirectional exchange of coded video data, the terminals 110, 120 may contain components to support exchange of coded video data in a complementary direction, from the second terminal 120 to the first terminal 110. Thus, the second terminal 120 also may possess a video source 132 that provides a second source video sequence, a video coder 134 that codes the second source video sequence and a transceiver 136 that transmits the second coded video sequence to the first terminal. In practice, the transceivers 122 and 136 may be components of a common transmitter/receiver system. Similarly, the first terminal 110 may possess its own transceiver 142 that receives the second coded video sequence from the network, a video decoder 144 that decodes the second coded video sequence and a video sink 146. The transceivers 116 and 142 may also be components of a common transmitter/receiver system. Operation of the coder and decoder components 132-136 and 142-146 may mimic operation described above for components 112-116 and 122-126.

Although the terminals 110, 120 are illustrated, respectively, as a smartphone and smart watch in FIG. 1, they may be provided as a variety of computing platforms, including servers, personal computers, laptop computers, tablet computers, media players and/or dedicated video conferencing equipment. For purposes of the present discussion, the type of terminal equipment is immaterial to the present discussion unless discussed hereinbelow.

In an embodiment, the communication network 130 may provide low-latency communication between the first and second terminals 110, 120. It is expected that the communication network 130 may provide communication between the first and second terminals 110, 120 with short enough latencies that round-trip communication delay between the first and second terminals 110, 120 generally coincides with the coding frame rates maintained by the video coder 114 and video decoder 124. The first and second terminals 110, 120 may communicate according to a protocol employing immediate acknowledgments of transmission units, either upon reception of properly-received transmission units or upon detection of a missing transmission unit (one that was not received properly). Thus, a coding terminal 110 may alter its selection of coding modes for a new frame based on a determination of whether an immediately-previously coded frame was received properly at the second terminal 120.

In an embodiment, a video coder may select a coding mode for a coding unit of a new input frame in response to real-time data identifying a state of communication between the terminal in which the video coder operates and a terminal that will receive and decode coded video data. For example, when a communication failure causes a decoder to fail to receive coded video data for a portion of a frame, a video coder may code a co-located portion of a new input frame according to an intra-coding mode, which causes prediction references for that portion to refer solely to the new frame. In this manner, the video coder provides nearly instantaneous recovery from the communication failure for subsequent video frames.

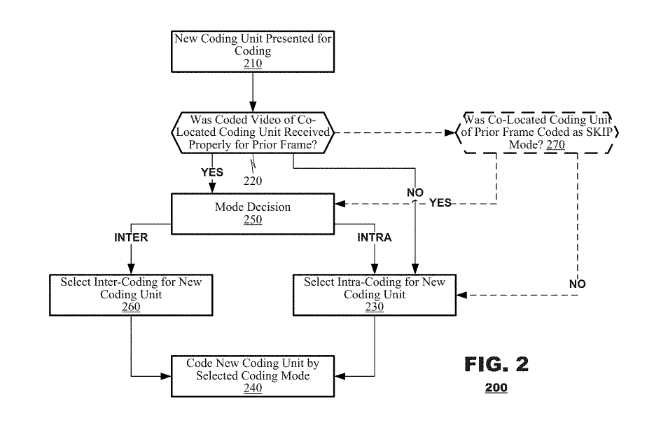

FIG. 2 illustrates a method 200 according to an embodiment of the present disclosure. The method 200 may begin when a new coding unit is presented for coding (box 210). The method 200 may determine whether coded video data of a co-located portion from a previous frame was received by a decoder without error (box 220). If not, if the coded video data of the co-located portion was not received properly by the decoder, the method 200 may select intra coding for the new coding unit (box 230). The method 200 may code the coding unit according to the selected mode (box 240).

If the coded video data of the co-located portion was received properly by the decoder, the method 200 may perform a coding mode selection according to its default processes (box 250). In some cases, the coding mode selection may select intra-coding for the new coding unit (box 230) but, in other cases, the coding mode selection may select inter-coding for the new coding unit (box 260). Once a coding mode selection has been made for the new coding unit, the method 200 may code the coding unit according to the selected mode (box 240).

The method 200 may repeat for as many coding units as are contained in an input frame and, thereafter, may repeat on a frame-by-frame basis.

In an embodiment, when coding a new coding unit, the method 200 may determine whether a co-located coding unit of a most recently coded frame was coded according to a SKIP mode (box 270). This determination may be performed either before or after the determination identified in box 220. If the co-located coding unit was coded according to SKIP mode coding, then the method 200 may advance to the mode decision determination shown in box 250. If the co-located coding unit was not coded according to SKIP mode coding, then the method 200 may perform the operations described hereinabove. In the flow diagram illustrated in FIG. 2, the method 200 would advance to box 230 and apply intra-coding to the new coding unit. In other implementations, where the operations of box 270 precede the operations of box 220, the method 200 would advance to box 220 on a determination that SKIP mode coding was not applied to the co-located coding unit of the preceding frame.

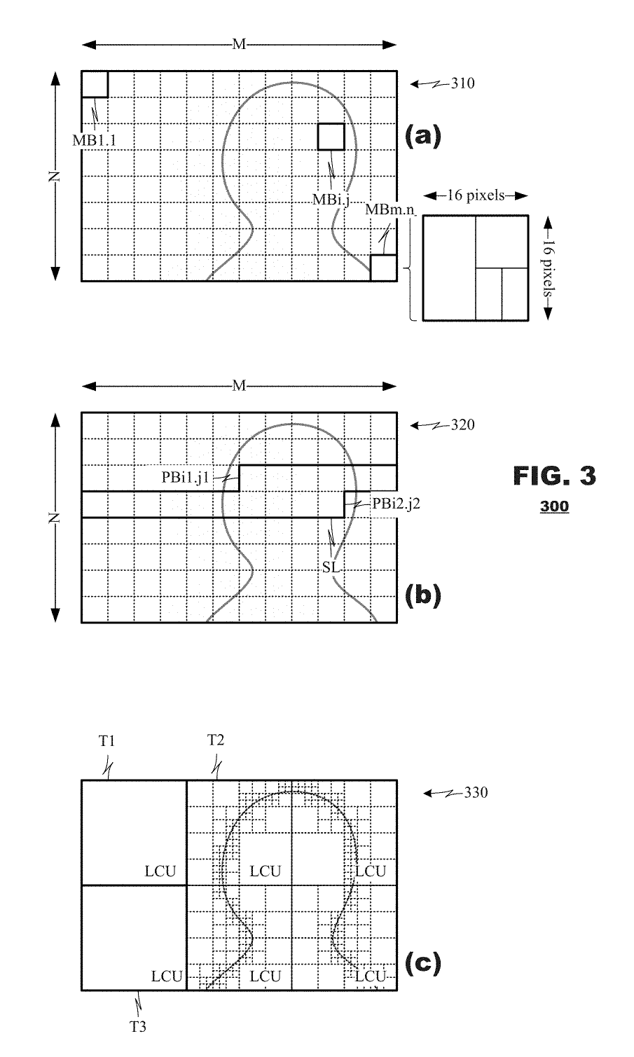

The method 200 of FIG. 2 may be performed on coding units of different granularities, which may be defined differently for different coding standards. For example, as illustrated in FIG. 3(a), video coders may partition input frames 310 into an M×N array macroblocks MB_{1,1}-MB_{m,n}, where each macroblock corresponds to a 16 pixel by 16 pixel array of luminance data. Such partitioning is common in, for example, video coders operating according to the H.261 (MPEG-1 Part 2) protocol, the H.262 (MPEG-2 Part 2) protocol, the H.263 (MPEG-4 Part 2) protocol and the H.264 (MPEG-4 AVC) protocol.

In such an embodiment, the method 200 may be performed individually on each macroblock as it is processed by a video coder (FIG. 1). Thus, as illustrated in FIG. 3(a), when the method 200 operates on a macroblock MB_{i,j} of a new frame 310, it may determine whether co-located macroblocks (e.g., a macroblock at location i,j and its adjacent macroblocks within the inter-prediction range) from the most-recently coded frame (not shown) was properly received by a decoder. If not, the method 200 may assign an intra-coding mode to the macroblock MB_{i,j} in the new frame 310.

In another embodiment, the method 200 may be performed on coding units of higher granularity. For example, the H.264 (MPEG-4 AVC) protocol defines a “slice” to include a plurality of consecutive pixel blocks that are coded in sequence separately from any other region in the same frame 320. In an embodiment, the method 200 may perform its analysis using a slice as a coding unit. In such an embodiment, the method 200 may code all pixel blocks in a slice according to intra-coding if the method 200 determines that the co-located slice of the prior frame (not shown) was not properly received by a decoder.

In the example illustrated in FIG. 3(b), a slice SL is shown as extending from a pixel block at location i1, j1 to another pixel block at location i2, j2. In this embodiment, when the method 200 operates on pixel blocks within this slice SL, it may determine whether co-located pixel blocks from the most recently preceding coded frame were properly received by a decoder. If not, the method 200 may assign intra-coding modes to the pixel blocks in the slice SL.

In another embodiment, the method 200 may be performed on coding units such as those defined according to tree structures as in H.265 (High Efficiency Video Coding, HEVC). FIG. 3(c) illustrates an exemplary frame that is partitioned according to a plurality of tiles T₁-T₃ (a total of 3 tiles in this example) according to a predetermined partitioning scheme. In HEVC, each tile is a rectangular region of the video consisting of one or more coding units. For example, in HEVC, a largest coding unit (commonly, “LCU”) is defined to have a predetermined size, for example, 64×64 pixels. Moreover, each LCU may be partitioned recursively into smaller coding units based on the information content of the input frame. Thus, in the simplified example of FIG. 3(c), coding units of successively smaller sizes are defined about a boundary portion of frame content between a foreground object and a background object. Further partitioning (not shown) may be performed based on other differences in image content, for example, between different elements of foreground content.

In the embodiment of FIG. 3(c), the method 200 may develop tiles from one or more LCUs of frame 330. In the example of FIG. 3(c), tiles T1 and T3 are illustrated as having a single LCU apiece and tile T2 is illustrated as formed from a 2×2 array of LCUs. Different embodiments may develop tiles from different allocations for LCUs as circumstances warrant.

Similar to FIG. 3(a), in such an embodiment for FIG. 3(c), the method 200 may be performed individually for each tile. When the method 200 operates on a tile, it may determine whether co-located tiles (including those tiles within the inter-prediction range) in the most recently coded frame was properly received by the decoder. If not, the method 200 may assign an intra-coding mode for the tile (and to sub-elements within the tiles, LCUs and lower-granularity coding units).

In an embodiment, it may be convenient to operate the method 200 at granularities that correspond to data that is encapsulated by transmission units developed by the transceiver 116 (FIG. 1). Thus, if a single transmission unit carries a single macroblock, it likely will be convenient to operate the method 200 at a granularity of a single macroblock. If a single transmission unit carries data of a slice, it likely will be convenient to operate the method 200 at a granularity of a slice. If a single transmission unit carries data of a coded frame, it likely will be convenient to operate the method 200 at a granularity of a frame. In a typical network, many transmission units may be aggregated to a packet for transmission purpose to improve the efficiency. Each transmission unit may be individually acknowledged within a block acknowledgement.

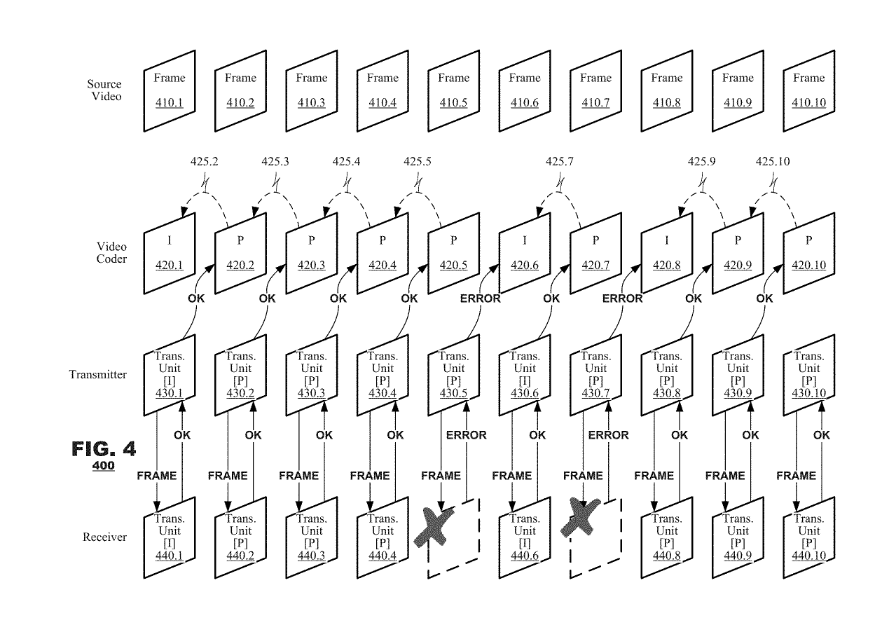

FIG. 4 illustrates application of the method 200 of FIG. 2 to coding of a sequence of source video in the presence of transmission errors within a network. FIG. 4 illustrates a sequence of frames 410.1-410.10 that will be coded by a video coder, transmitted by a transmitter of an encoding terminal and received by a receiver of a decoding terminal. Thus, in this example for better illustration, the transmission units and coding units both operate at frame-level granularity.

A first frame 410.1 of the sequence may be coded by intra-coding, which generates an Intra-coded (I) frame 420.1. The I frame 420.1 may be placed into a transmission unit 430.1, which is transmitted by the transmitter and, in this example, received properly by the receiver as a transmission unit 440.1. The receiver may generate an acknowledgement message indicating successful reception of the transmission unit 430.1 (shown as “OK”). In response to the acknowledgement message, the transmitter may provide the video coder an indication that the transmission unit 430.1 was successfully received by the receiver (also shown as “OK”). In response, the video coder may perform coding mode selections for a next frame 410.2 according to its ordinary processes. In this example, the video coder may apply inter-coding to the frame 410.2 using the coded I frame 420.1 as a prediction reference (shown by prediction arrow 415.2). The inter-frame Predictive-coded (P) frame 420.2 may be placed into another transmission unit 430.2, which is transmitted by the transmitter.

In the example of FIG. 4, transmission units 430.1-430.4 of coded video frames 420.1-420.4 are illustrated as being received successfully at the receiver as received transmission units 440.1-440.4. Thus, the video coder may apply its default coding mode selections for source frames 410.2-410.5. In this example, each of the frames 410.2-410.5 are shown as coded according to inter-coding, which generates P frames 420.2-420.5.

A transmission error occurs at frame 410.5 in the example of FIG. 4. When P frame 420.5 is transmitted as transmission unit 430.5, a transmission error prevents the transmission unit 430.5 from being received successfully at the receiver. In response, the receiver may transmit a notification to the transmitter that the transmission unit 430.5 was not successfully received (shown as “Error”). With the prior knowledge that the round-trip delay of the network is small, in practice, if a notification or ACK is not received by the transmitter, the transmitter may interpret that the frame 430.5 is corrupted. In response to the error message, the transmitter may provide the video coder an indication that the transmission unit 430.5 was not successfully received by the receiver (also shown as “Error”). In response, the video coder may assign an intra-coding mode to the next frame 410.6 in the video sequence. The video coder may generate an I frame 420.6, which may be transmitted in the next transmission unit 430.6. If the transmission unit 440.6 is successfully received, then the transmission error at frame 410.5 causes only a single-frame loss of content. The receiver's terminal may output useful video content immediately after decoding the I frame in transmission unit 440.6.

In the example of FIG. 4, the transmission unit 440.6 is acknowledged as received successfully, which, when propagated back to the video coder, allows the video coder to resume mode selection according to its ordinary processes. Thus, FIG. 4 shows frame 410.7 being coded as a P frame 420.7.

The process of checking transmission status of a previously-coded frame before selecting a coding mode for a new frame may be performed throughout a coding session. Thus, as new frames are identified as unsuccessfully received at a receiving terminal, a video coder may select an intra-coding mode for a next frame in a video sequence. FIG. 4, for example, illustrates a transmission error for transmission unit 430.7, which causes the video coder to code the next source frame 410.8 as an I frame 420.8.

The principles of the present disclosure work cooperatively with a variety of different default mode selection techniques. In addition to the detection of a scene change, many mode selection techniques will apply intra coding to coding units even when other coding modes are likely to achieve higher bandwidth savings. For example, a video coder may apply intra-coding to coding units to limit coding errors that can arise due to long inter-coding prediction chains or to support random access playback modes. The techniques described herein find application with such protocols.

The principles of the present disclosure find application in communication environments where a communication network 130 (FIG. 1) that extends between encoder and decoder terminals 110, 120 provides round-trip communication latencies that are shorter than the durations of frames being coded. Table 1 identifies frame durations for several different commonly-used frame rates in video applications:

TABLE 1

| Frame | Frame |
|---|---|
| rate (fps) | Duration (ms) |
| 30 | 33.3 |
| 60 | 16.7 |
| 120 | 8.3 |
| 240 | 4.2 |

Thus, the techniques described herein find application in networking environments where a terminal 110 receives an acknowledgment message corresponding to a given coding unit prior to coding a co-located coding unit of a next frame in a video sequence.

WiFi networks as defined in IEEE 802.11 standard allow either explicit or implicit immediate ACK modes for the acknowledgement of a block of transmission units. The transmitter of 116 may explicitly send a block ACK request to the receiver of 122 for the acknowledgements of a block of transmission units. As an immediate response, the transceiver 122 may send the block of acknowledgements back to the transceiver 116 without any additional delay. After sending an aggregated of transmission units from 116 to 122, the transceiver 122 may send back the block of acknowledgements back to transceiver 116 immediately, called implicit immediate ACK. For implicit immediate ACK, the block ACK request is not a standalone packet by itself but implicitly embedded in the aggregation of transmission units. In the case with re-transmission, the acknowledgements of the same transmission unit can be combined to indicate whether the transmission unit is received by the receiver successfully after some number of possible retries within the frame duration of Table 1.

A typical WiFi network has a range from a few to 300 feet, and the propagation delay between devices in the air is less than 1 μs. If the system 100 (FIG. 1) can access the network 130 without competition from other systems on the same or adjacent networks, using either implicit or explicit immediate block ACK, the round-trip network latency of a WiFi network can be controlled within a fraction of a millisecond (ms), which is far less than the frame durations illustrated in Table 1. To enable a wireless station to access the network without or with less competition, the network can implement HCF (hybrid coordination function) controlled channel access (HCCA) or service period channel access (SPCA), both defined in IEEE 802.11, with better guarantees of channel access.

Currently, the four-generation (4G) cellular network based on long-term evolution advanced (LTE-A) release defines a latency less than 5 ms between devices. The future 5G wireless network is expected to have a design goal to have a round-trip latency between devices less than 1 ms. The round-trip latency of advanced 4G and future 5G networks typically will allow an ACK for a transmitted coded frame to arrive before the coding of a next video frame.

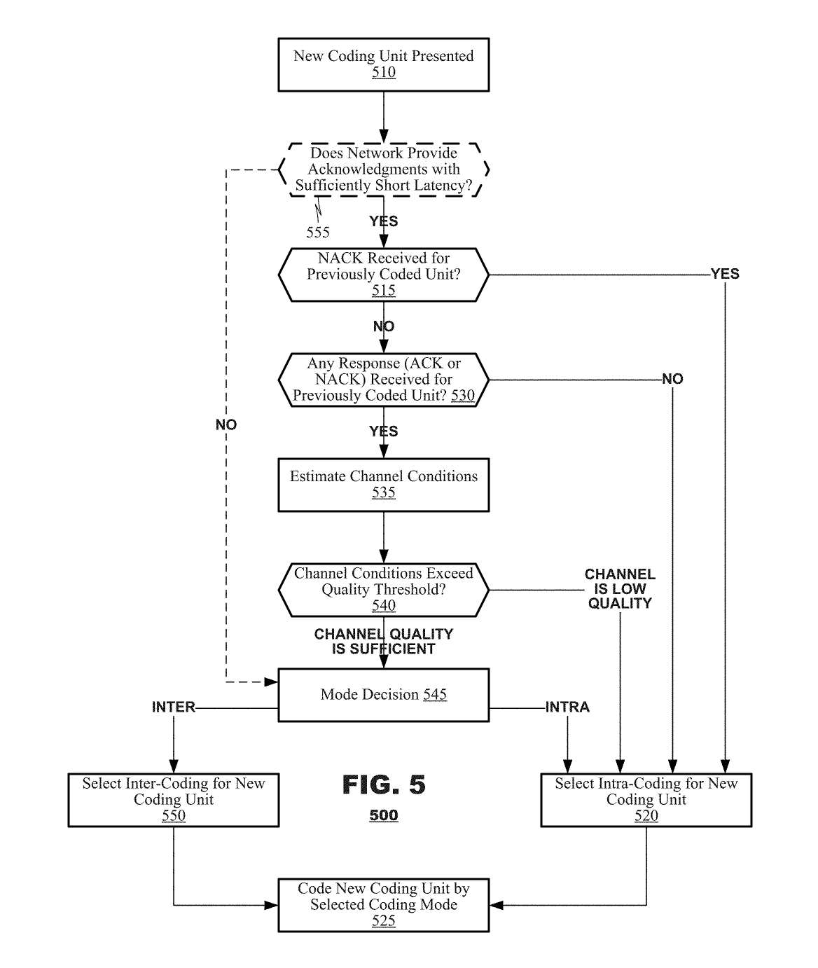

FIG. 5 is a flow diagram of a method 500 according to another embodiment of the present invention. The method 500 may begin when a new coding unit is presented for coding (box 510). The method 500 may determine whether a negative acknowledgement message (NACK) has been received for a previously-coded co-located coding unit (box 515). If so, the method 500 may select intra-coding as the coding mode for the new coding unit (box 520).

If, at box 515, the method 500 determines that no NACK was received, the method 500 may determine whether any acknowledgement message, either a positive acknowledgement message or a negative acknowledgment was received for the previously-coded co-located coding unit (box 530). If no acknowledgement message has been received, the method 500 may advance to box 520 and select intra-coding as the coding mode for the new coding unit.

If, at box 515, the method determines that an acknowledgement message was received, the method 500 may estimate channel conditions between a transmitter of the encoding terminal and a receiver of the decoding terminal (box 535). Channel conditions may be estimated from estimates of received signal strength (commonly “RSSI”) determined by a transmitter from measurements performed on signals from the receiver or network, from estimates of bit error rates or packet error rates in the network or from estimates of rates of NACK messages received from the receiver in response to other transmission units. The method 500 may determine whether its estimates of channel quality exceed a predetermined threshold (box 540). If the determination indicates that the channel has low quality, the method 500 may advance to box 520 and select intra-coding as the coding mode for the new coding unit. If the determination indicates that the channel has sufficient quality, the method 500 may perform a coding mode selection according to its default processes (box 545). In some cases, the coding mode selection may select intra-coding for the new coding unit (box 520) but, in other cases, the coding mode selection may select inter-coding for the new coding unit (box 550). Once a coding mode selection has been made for the new coding unit, the method 500 may code the coding unit according to the selected mode (box 525). In some cases, a poor channel quality may lead to lower the transmission rate for the wireless network. The new transmission rate may feedback to the video encoder to increase the video compression ratio.

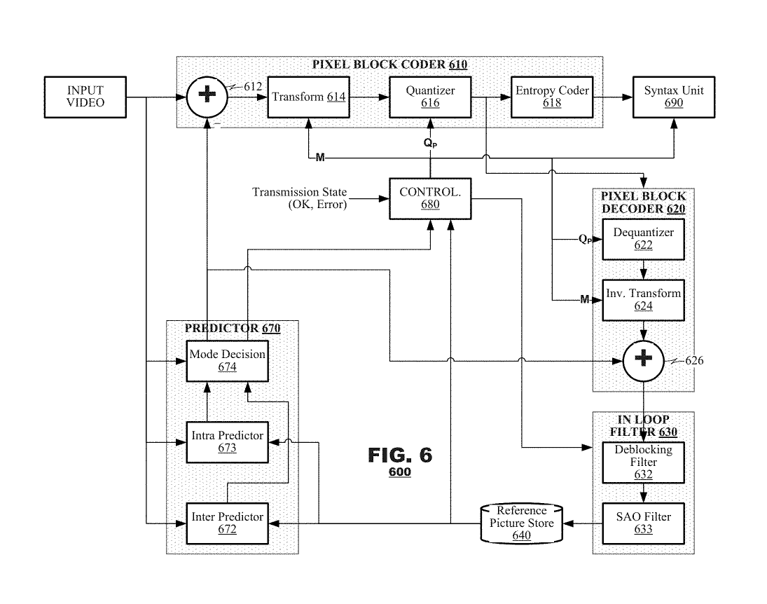

FIG. 6 is a functional block diagram of a coding system 600 according to an embodiment of the present disclosure. The system 600 may include a pixel block coder 610, a pixel block decoder 620, an in-loop filter system 630, a reference picture store 640, a predictor 670, a controller 680, and a syntax unit 690. The pixel block coder and decoder 610, 620 and the predictor 670 may operate iteratively on individual pixel blocks of a picture. The predictor 670 may predict data for use during coding of a newly-presented input pixel block. The pixel block coder 610 may code the new pixel block by predictive coding techniques and present coded pixel block data to the syntax unit 690. The pixel block decoder 620 may decode the coded pixel block data, generating decoded pixel block data therefrom. The in-loop filter 630 may perform various filtering operations on a decoded picture that is assembled from the decoded pixel blocks obtained by the pixel block decoder 620. The filtered picture may be stored in the reference picture store 640 where it may be used as a source of prediction of a later-received pixel block. The syntax unit 690 may assemble a data stream from the coded pixel block data which conforms to a governing coding protocol.

The pixel block coder 610 may include a subtractor 612, a transform unit 614, a quantizer 616, and an entropy coder 618. The pixel block coder 610 may accept pixel blocks of input data at the subtractor 612. The subtractor 612 may receive predicted pixel blocks from the predictor 670 and generate an array of pixel residuals therefrom representing a difference between the input pixel block and the predicted pixel block. The transform unit 614 may apply a transform to the sample data output from the subtractor 612, to convert data from the pixel domain to a domain of transform coefficients. The quantizer 616 may perform quantization of transform coefficients output by the transform unit 614. The quantizer 616 may be a uniform or a non-uniform quantizer. The entropy coder 618 may reduce bandwidth of the output of the coefficient quantizer by coding the output, for example, by variable length code words.

The transform unit 614 may operate in a variety of transform modes as determined by the controller 680. For example, the transform unit 614 may apply a discrete cosine transform (DCT), a discrete sine transform (DST), a Walsh-Hadamard transform, a Haar transform, a wavelet transform, or the like. In an embodiment, the controller 680 may select a coding mode M to be applied by the transform unit 615, may configure the transform unit 615 accordingly and may signal the coding mode M in the coded video data, either explicitly or impliedly.

The quantizer 616 may operate according to a quantization parameter Q_{P} that is supplied by the controller 680. In an embodiment, the quantization parameter Q_{P} may be applied to the transform coefficients as a multi-value quantization parameter, which may vary, for example, across different coefficient locations within a transform-domain pixel block. Thus, the quantization parameter Q_{P} may be provided as a quantization parameters array.

The pixel block decoder 620 may invert coding operations of the pixel block coder 610. For example, the pixel block decoder 620 may include a dequantizer 622, an inverse transform unit 624, and an adder 626. The pixel block decoder 620 may take its input data from an output of the quantizer 616. Although permissible, the pixel block decoder 620 need not perform entropy decoding of entropy-coded data since entropy coding is a lossless event. The dequantizer 622 may invert operations of the quantizer 616 of the pixel block coder 610. The dequantizer 622 may perform uniform or non-uniform de-quantization as specified by the decoded signal Q_{P}. Similarly, the inverse transform unit 624 may invert operations of the transform unit 614. The dequantizer 622 and the inverse transform unit 624 may use the same quantization parameters Q_{P} and transform mode M as their counterparts in the pixel block coder 610. Quantization operations likely will truncate data in various respects and, therefore, data recovered by the dequantizer 622 likely will possess coding errors when compared to the data presented to the quantizer 616 in the pixel block coder 610.

The adder 626 may invert operations performed by the subtractor 612. It may receive the same prediction pixel block from the predictor 670 that the subtractor 612 used in generating residual signals. The adder 626 may add the prediction pixel block to reconstructed residual values output by the inverse transform unit 624 and may output reconstructed pixel block data.

The in-loop filter 630 may perform various filtering operations on recovered pixel block data. For example, the in-loop filter 630 may include a deblocking filter 632 and a sample adaptive offset (SAO) filter 633. The deblocking filter 632 may filter data at seams between reconstructed pixel blocks to reduce discontinuities between the pixel blocks that arise due to coding. SAO filters may add offsets to pixel values according to an SAO “type,” for example, based on edge direction/shape and/or pixel/color component level. The in-loop filter 630 may operate according to parameters that are selected by the controller 680.

The reference picture store 640 may store filtered pixel data for use in later prediction of other pixel blocks. Different types of prediction data are made available to the predictor 670 for different prediction modes. For example, for an input pixel block, intra prediction takes a prediction reference from decoded data of the same picture in which the input pixel block is located. Thus, the reference picture store 640 may store decoded pixel block data of each picture as it is coded. For the same input pixel block, inter prediction may take a prediction reference from previously coded and decoded picture(s) that are designated as reference pictures. Thus, the reference picture store 640 may store these decoded reference pictures.

As discussed, the predictor 670 may supply prediction data to the pixel block coder 610 for use in generating residuals. The predictor 670 may include an inter predictor 672, an intra predictor 673 and a mode decision unit 674. The inter predictor 672 may receive pixel block data representing a new pixel block to be coded and may search the reference picture store 640 for pixel block data from reference picture(s) for use in coding the input pixel block. The inter predictor 672 may support a plurality of prediction modes, such as P mode coding and Bidirectional-predictive-coded (B) mode coding, although the low latency requirements may not allow B mode coding. The inter predictor 672 may select an inter prediction mode and an identification of candidate prediction reference data that provides a closest match to the input pixel block being coded. The inter predictor 672 may generate prediction reference metadata, such as motion vectors, to identify which portion(s) of which reference pictures were selected as source(s) of prediction for the input pixel block.

The intra predictor 673 may support Intra-coded (I) mode coding. The intra predictor 673 may search from among reconstructed pixel block data from the same picture as the pixel block being coded that provides a closest match to the input pixel block. The intra predictor 673 also may generate prediction reference indicators to identify which portion of the picture was selected as a source of prediction for the input pixel block.

The mode decision unit 674 may select a final coding mode to be applied to the input pixel block. Typically, as described above, the mode decision unit 674 selects the prediction mode that will achieve the lowest distortion when video is decoded given a target bitrate. Exceptions may arise when coding modes are selected to satisfy other policies to which the coding system 600 adheres, such as satisfying a particular channel behavior, or supporting random access or data refresh policies. When the mode decision selects the final coding mode, the mode decision unit 674 may output a reference block from the store 640 to the pixel block coder and decoder 610, 620 and may supply to the controller 680 an identification of the selected prediction mode along with the prediction reference indicators corresponding to the selected mode.

The controller 680 may control overall operation of the coding system 600. The controller 680 may select operational parameters for the pixel block coder 610 and the predictor 670 based on analyses of input pixel blocks and also external constraints, such as coding bitrate targets and other operational parameters. As is relevant to the present discussion, the controller 680 may force the predictor 670 to select an intra coding mode in response to an indication of a transmission error involving a co-located coded pixel block. Moreover, it may select quantization parameters Q_{P}, the use of uniform or non-uniform quantizers, and/or the transform mode M, it may provide those parameters to the syntax unit 690, which may include data representing those parameters in the data stream of coded video data output by the system 600.

During operation, the controller 680 may revise operational parameters of the quantizer 616 and the transform unit 615 at different granularities of image data, either on a per pixel block basis or on a larger granularity (for example, per frame, per slice, per tile, per LCU or another region). In an embodiment, the quantization parameters may be revised on a per-pixel basis within a coded picture.

Additionally, as discussed, the controller 680 may control operation of the in-loop filter 630 and the prediction unit 670. Such control may include, for the prediction unit 670, mode selection (lambda, modes to be tested, search windows, distortion strategies, etc.), and, for the in-loop filter 630, selection of filter parameters, reordering parameters, weighted prediction, etc.

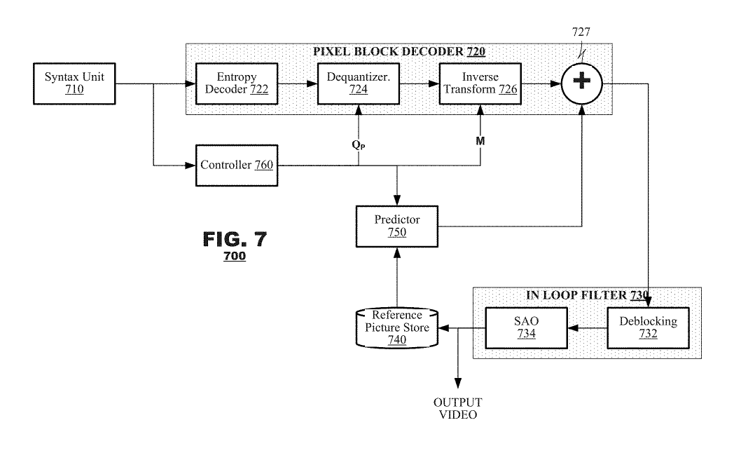

FIG. 7 is a functional block diagram of a decoding system 700 according to an embodiment of the present disclosure. The decoding system 700 may include a syntax unit 710, a pixel block decoder 720, an in-loop filter 730, a reference picture store 740, a predictor 750 and a controller 760. The syntax unit 710 may receive a coded video data stream and may parse the coded data into its constituent parts. Data representing coding parameters may be furnished to the controller 760 while data representing coded residuals (the data output by the pixel block coder 210 of FIG. 2) may be furnished to the pixel block decoder 720. The pixel block decoder 720 may invert coding operations provided by the pixel block coder (FIG. 2). The in-loop filter 730 may filter reconstructed pixel block data. The reconstructed pixel block data may be assembled into pictures for display and output from the decoding system 700 as output video. The pictures also may be stored in the prediction buffer 740 for use in prediction operations. The predictor 750 may supply prediction data to the pixel block decoder 720 as determined by coding data received in the coded video data stream.

The pixel block decoder 720 may include an entropy decoder 722, a dequantizer 724, an inverse transform unit 726, and an adder 728. The entropy decoder 722 may perform entropy decoding to invert processes performed by the entropy coder 718 (FIG. 7). The dequantizer 724 may invert operations of the quantizer 716 of the pixel block coder 710 (FIG. 7). Similarly, the inverse transform unit 726 may invert operations of the transform unit 714 (FIG. 7). They may use the quantization parameters Q_{P} and transform modes M that are provided in the coded video data stream. Because quantization is likely to truncate data, the data recovered by the dequantizer 724, likely will possess coding errors when compared to the input data presented to its counterpart quantizer 716 in the pixel block coder 210 (FIG. 2).

The adder 728 may invert operations performed by the subtractor 712 (FIG. 7). It may receive a prediction pixel block from the predictor 750 as determined by prediction references in the coded video data stream. The adder 728 may add the prediction pixel block to reconstructed residual values output by the inverse transform unit 726 and may output reconstructed pixel block data.

The in-loop filter 730 may perform various filtering operations on reconstructed pixel block data. As illustrated, the in-loop filter 730 may include a deblocking filter 732 and an SAO filter 734. The deblocking filter 732 may filter data at seams between reconstructed pixel blocks to reduce discontinuities between the pixel blocks that arise due to coding. SAO filters 734 may add offset to pixel values according to an SAO type, for example, based on edge direction/shape and/or pixel level. Other types of in-loop filters may also be used in a similar manner. Operation of the deblocking filter 732 and the SAO filter 734 ideally would mimic operation of their counterparts in the coding system 700 (FIG. 7). Thus, in the absence of transmission errors or other abnormalities, the decoded picture obtained from the in-loop filter 730 of the decoding system 700 would be the same as the decoded picture obtained from the in-loop filter 730 of the coding system 700 (FIG. 7); in this manner, the coding system 700 and the decoding system 700 should store a common set of reference pictures in their respective reference picture stores 740, 740.

The reference picture stores 740 may store filtered pixel data for use in later prediction of other pixel blocks. The reference picture stores 740 may store decoded pixel block data of each picture as it is coded for use in intra prediction. The reference picture stores 740 also may store decoded reference pictures.

As discussed, the predictor 750 may supply prediction data to the pixel block decoder 720. The predictor 750 may supply predicted pixel block data as determined by the prediction reference indicators supplied in the coded video data stream.

The controller 760 may control overall operation of the coding system 700. The controller 760 may set operational parameters for the pixel block decoder 720 and the predictor 750 based on parameters received in the coded video data stream. As is relevant to the present discussion, these operational parameters may include quantization parameters Q_{P} for the dequantizer 724 and transform modes M for the inverse transform unit 715. As discussed, the received parameters may be set at various granularities of image data, for example, on a per pixel block basis, a per picture basis, a per slice basis, a per tile basis, a per LCU basis, or based on other types of regions defined for the input image.

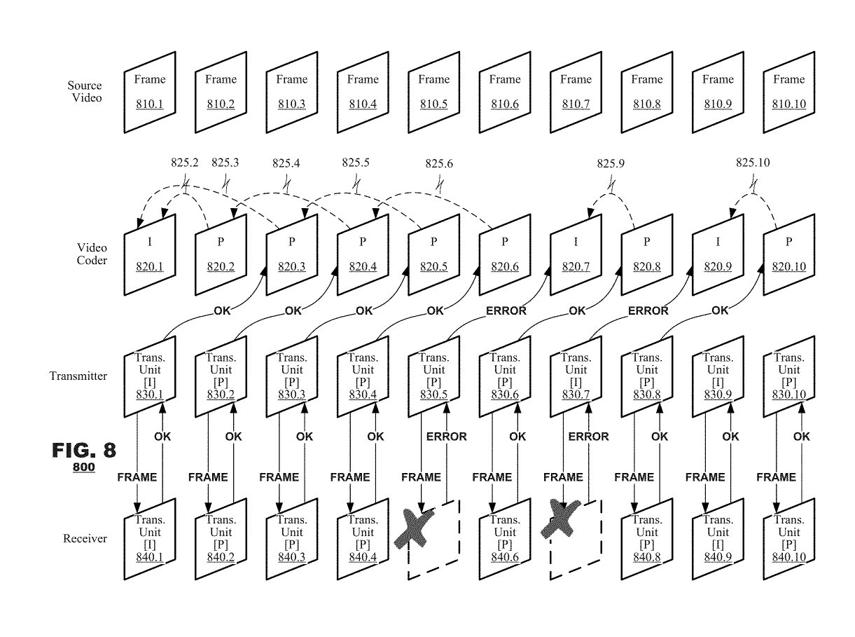

As discussed, the principles of the present invention find application in low-latency communication environments where transmission errors can be detected quickly. In the ideal case, illustrated in FIG. 4, transmission errors involving a given piece of coded content (for example, a coded frame, slice or macroblock) will be detected before a co-located piece of content from a next frame will be coded. The principles of the present disclosure, however, find application in other communication environments, where transmissions errors are detected quickly but not before coding decisions are made to the next frame. In FIG. 8, for example, coding errors for a given frame are received by a video coder before coding decisions are made for a second frame following the erroneously-transmitted frame.

FIG. 8 illustrates application of the method 200 of FIG. 2 to coding of a sequence of source video in the presence of transmission errors within such a network. FIG. 8 illustrates a sequence of frames 810.1-810.10 that will be coded by a video coder, transmitted by a transmitter of an encoding terminal and received by a receiver of a decoding terminal. Thus, in this example, the transmission units and coding units both operate at frame-level granularity.

A first frame 810.1 of the sequence may be coded by intra-coding, which generates an “I” frame 820.1. The I frame 820.1 may be placed into a transmission unit 830.1, which is transmitted by the transmitter and, in this example, received properly by the receiver as a transmission unit 840.1. The receiver may generate an acknowledgement message indicating successful reception of the transmission unit 830.1 (shown as “OK”). In response to the acknowledgement message, the transmitter may provide the video coder an indication that the transmission unit 830.1 was successfully received by the receiver (also shown as “OK”). By the time the acknowledgment is received, the video coder may have coded the next frame 810.2 in the video sequence; which may have been coded on an inter-frame on a speculative assumption that frame 820.1 is successfully received. The transmission acknowledgement for transmission unit 830.1, however, confirms that coded frame 820.1 was successfully received, which may be applied to coding of frame 810.3. When coding frame 810.3, the video coder may use coded frame 820.1 as a source of prediction for coded frame 820.3, represented by prediction arrow 825.3. The inter-coded “P” frame 820.3 may be placed into another transmission unit 830.3, which is transmitted by the transmitter.

In the example of FIG. 8, transmission units 830.1-830.4 of coded video frames 820.1-420.4 are illustrated as being received successfully at the receiver as received transmission units 840.1-440.4. Thus, the video coder may apply its default coding mode selections for source frames 810.3-810.6. In this example, each of the frames 810.3-810.6 are shown as coded according to inter-coding, which generates P frames 820.3-820.6. The prediction vectors for each of these coded frames 820.3-820.6 each may rely on the most recently acknowledged transmission unit that was available to the video coder at the time the frames 810.3-810.6 respectively were coded.

A transmission error occurs at frame 810.5 in the example of FIG. 8. When P frame 820.5 is transmitted as transmission unit 830.5, a transmission error prevents the transmission unit 830.5 from being received successfully at the receiver. In response, the receiver may transmit a notification to the transmitter that the transmission unit 830.5 was not successfully received (shown as “Error”). In response to the error message, the transmitter may provide the video coder an indication that the transmission unit 830.1 was not successfully received by the receiver (also shown as “Error”), which is received at the time that the frame 810.7 is to be coded. In response, the video coder may assign an intra-coding mode to the next frame 810.7 to be coded. The video coder may generate an I frame 820.7, which may be transmitted in the next transmission unit 830.7. If the transmission unit 840.7 is successfully received, then the transmission error at frame 810.5 causes only a single-frame loss of content. The coded frame 830.6 will have been coded and transmitted to the receiver prior to processing of the error message that corresponds to the lost transmission unit 840.5. Moreover, the video coder will transmit the transmission unit 830.7 corresponding to the coded I frame which, if successfully received, would result in only a single coded frame being lost. FIG. 8 shows a second transmission error, however, involving transmission unit 830.7, which is a separate error event.

As illustrated in FIG. 8, the frame 810.6 may be coded as a P frame 820.6 because transmission unit 840.4 was successfully received. Thus, the coded frame may be sent to a receiver notwithstanding the transmission error involving transmission unit 830.5.

The process of checking transmission status of a previously-coded frame before selecting a coding mode for a new frame may be performed throughout a coding session. Thus, as new frames are identified as unsuccessfully received at a receiving terminal, a video coder may select an intra-coding mode for a next frame in a video sequence. FIG. 8, for example, illustrates a second transmission error for transmission unit 830.7, which causes the video coder to code the source frame 810.9 as an I frame 820.9. Frame 810.8, however, may be coded as a P frame based on the transmission unit 840.6, which is acknowledged by the receiver.

Thus, as shown above, the principles of the present disclosure also protect against transmission errors even in the case where acknowledgement of transmission errors for coded video data are processed by video coders with latency of a 1-2 intervening frames.

The foregoing discussion has described operation of the embodiments of the present disclosure in the context of terminals that embody encoders and/or decoders. Commonly, these components are provided as electronic devices. They can be embodied in integrated circuits, such as application specific integrated circuits, field programmable gate arrays and/or digital signal processors. Alternatively, they can be embodied in computer programs that execute on personal computers, notebook computers, tablet computers, smartphones, video game consoles, or computer servers. Such computer programs typically are stored in physical storage media such as electronic-, magnetic- and/or optically-based storage devices, where they are read to a processor under control of an operating system and executed. Similarly, decoders can be embodied in integrated circuits, such as application specific integrated circuits, field-programmable g ate arrays and/or digital signal processors, or they can be embodied in computer programs that are stored by and executed on personal computers, notebook computers, tablet computers, smartphones or computer servers. Decoders commonly are packaged in consumer electronics devices, such as video display, gaming systems, DVD players, portable media players and the like; and they also can be packaged in consumer software applications such as video games, browser-based media players and the like. And, of course, these components may be provided as hybrid systems that distribute functionality across dedicated hardware components and programmed general-purpose processors, as desired.

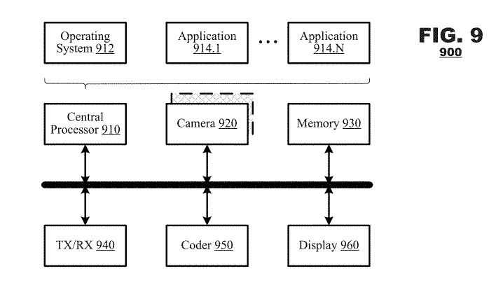

For example, the techniques described herein may be performed by a central processor of a computer system. FIG. 9 illustrates an exemplary computer system 900 that may perform such techniques. The computer system 900 may include a central processor 910, one or more cameras 920, a memory 930, and a transceiver 940 provided in communication with one another. The camera 920 may perform image capture and may store captured image data in the memory 930. Optionally, the device also may include sink components, such as a coder 950 and a display 960, as desired.

The central processor 910 may read and execute various program instructions stored in the memory 930 that define an operating system 912 of the system 900 and various applications 914.1-914.N. The program instructions may perform coding mode control according to the techniques described herein. As it executes those program instructions, the central processor 910 may read, from the memory 930, image data created either by the camera 920 or the applications 914.1-914.N, which may be coded for transmission. The central processor 910 may execute a program that operates according to the principles of FIG. 6. Alternatively, the system 900 may have a dedicated coder 950 provided as a standalone processing system and/or integrated circuit.

As indicated, the memory 930 may store program instructions that, when executed, cause the processor to perform the techniques described hereinabove. The memory 930 may store the program instructions on electrical-, magnetic- and/or optically-based storage media.

The transceiver 940 may represent a communication system to transmit transmission units and receive acknowledgement messages from a network (not shown). In an embodiment where the central processor 910 operates a software-based video coder, the transceiver 940 may place data representing state of acknowledgment message in memory 930 to retrieval by the processor 910. In an embodiment where the system 900 has a dedicated coder, the transceiver 940 may exchange state information with the coder 950.

Several embodiments of the disclosure are specifically illustrated and/or described herein. However, it will be appreciated that modifications and variations of the disclosure are covered by the above teachings and within the purview of the appended claims without departing from the spirit and intended scope of the disclosure.

We claim:

1. A video coding method, comprising:
determining, for a new coding unit presented for coding, a transmission state of a co-located coding unit from a preceding frame,
if the transmission state of the co-located coding unit from the preceding frame indicates an error, selecting an intra-coding mode for the new coding unit,
if the transmission state of the co-located coding unit from the preceding frame does not indicate an error, selecting a coding mode for the new coding unit according to a default process,
coding the new coding unit according to the selected coding mode, and
transmitting the coded coding unit across a network.

2. The method of claim 1, wherein the preceding frame is a frame immediately adjacent to a frame of the new coding unit in coding order.

3. The method of claim 1, wherein the preceding frame is a frame immediately adjacent to a frame of the new coding unit in temporal order.

4. The method of claim 1, wherein the preceding frame is a frame for which an acknowledgment is most-recently received from the network.

5. The method of claim 1, further comprising, if the co-located coding unit from the preceding frame is determined to have no confirmed state, selecting the intra-coding mode for the new coding unit.

6. The method of claim 1, wherein the new coding unit is a partition of a frame corresponding to a transmission unit of the network. The method of claim 1, wherein the new coding unit is an LCU.

8. The method of claim 1, wherein the new coding unit is a frame.

9. The method of claim 1, wherein the new coding unit is a slice.

10. The method of claim 1, wherein the new coding unit is a tile.

11. The method of claim 1, wherein the new coding unit is a macroblock.

12. A video coding method, comprising:
iteratively, for a plurality of frames in a video sequence and for each coding unit of the frame:
determining a transmission state of a co-located coding unit from a preceding frame,
when the transmission state of the co-located coding unit from the preceding frame indicates an error, selecting an intra-coding mode for the new coding unit,
when the transmission state of the co-located coding unit from the preceding frame does not indicate an error, selecting a coding mode for the new coding unit according to a default process,
coding the new coding unit according to the selected coding mode, and
transmitting the coded coding unit across a network in a transmission unit, wherein the transmission state of each coding unit is determined from error indicators from the network relating to the coding unit's transmission unit.

13. The method of claim 12, wherein the preceding frame is a frame immediately adjacent to a frame of the new coding unit in coding order.

14. The method of claim 12, wherein the preceding frame is a frame immediately adjacent to a frame of the new coding unit in temporal order.

15. The method of claim 12, wherein the new coding unit is a partition of a frame corresponding to a transmission unit of the network.

16. The method of claim 12, wherein the new coding unit is an LCU.

17. The method of claim 12, wherein the new coding unit is a frame.

18. The method of claim 12, wherein the new coding unit is a slice.

19. The method of claim 12, wherein the new coding unit is a tile.

20. The method of claim 12, wherein the new coding unit is a macroblock.

21. Apparatus, comprising:
a video source,
a video coder, having an input for frame data from the video source,
a transceiver, having an input for coded data from the video coder, the transceiver providing an interface to a network,
wherein the video coder operates according to a mode decision control in which, when a new coding unit is presented for coding:
determines a transmission state of a co-located coding unit from a preceding frame,
when the transmission state of the co-located coding unit from the preceding frame indicates an error, selects an intra-coding mode for the new coding unit,
when the transmission state of the co-located coding unit from the preceding frame does not indicate an error, selects a coding mode for the new coding unit according to a default process.

22. The apparatus of claim 21, wherein the preceding frame is a frame immediately adjacent to a frame of the new coding unit in coding order.

23. The apparatus of claim 21, wherein the preceding frame is a frame immediately adjacent to a frame of the new coding unit in temporal order.

24. The apparatus of claim 21, wherein the new coding unit is a partition of a frame corresponding to a transmission unit of the transceiver.

25. The apparatus of claim 21, wherein the new coding unit is an LCU partition of the input frame.

26. The apparatus of claim 21, wherein the new coding unit is a tile.

27. The apparatus of claim 21, wherein the new coding unit is a slice partition of the input frame.

28. The apparatus of claim 21, wherein the new coding unit is a macroblock partition of the input frame.

29. Computer readable medium storing program instructions that, when executed by a processing device, causes the device to:
when a new coding unit is presented for coding, determine a transmission state of a co-located coding unit from a preceding frame,
if the transmission state of the co-located coding unit from the preceding frame indicates an error, select an intra-coding mode for the new coding unit,
if the transmission state of the co-located coding unit from the preceding frame does not indicate an error, select a coding mode for the new coding unit according to a default process,
code the new coding unit according to the selected coding mode, and
transmit the coded coding unit across a network.

30. A video coding method, comprising:
estimating conditions of a network,
based on an estimate that the network is operating below a quality threshold, selecting an intra-coding mode for a new coding unit presented for coding,
otherwise, determining, for the new coding unit, a transmission state of a co-located coding unit from a preceding frame,
if the transmission state of the co-located coding unit from the preceding frame indicates an error, selecting an intra-coding mode for the new coding unit,
if the transmission state of the co-located coding unit from the preceding frame does not indicate an error, selecting a coding mode for the new coding unit according to a default process,
coding the new coding unit according to the selected coding mode, and
transmitting the coded coding unit across the network.
